(19) United States
(12) Patent Application Publication
(10) Pub. No.: US 2019/0138422 A1
(43) Pub. Date: May 9, 2019

(54) PREDICTIVE INSIGHT ANALYSIS OVER DATA LOGS

(71) Applicant: SAP SE, Walldorf (DE)

(72) Inventors: Corinna Wendisch, Mannheim (DE); Sergey Smirnov, Heidelberg (DE)

(21) Appl. No.: 15/803,490

(22) Filed: Nov. 3, 2017

(51) Int. Cl. G06F 11/34

(52) U.S. Cl. CPC G06F 11/3438; G06F 17/30867; G06F 11/3476

(57) ABSTRACT

Data is collected through a user interface application. The collected data is associated with a plurality of first events that define impacting events, and a plurality of second events that defined impacted events. The data includes relations, where a relation from the data associates a set of first events from the plurality of first events with a set of second events from the plurality of second events. A relation from the data represents a claimed association between impacting events and impacted events within a given evaluation scenario. The collected data is stored at a data log and is evaluated to determine occurrence of a set of pairs of events. A pair includes an event of the first event type and an event of the second event type. A set of causality measures corresponding to the pairs of events within a relation is computed.

### BACKGROUND

Software systems face harsh requirements when extracting knowledge from available data and leveraging the knowledge to accomplish customer goals. Intelligent applications may discover knowledge analyzing user behavior. For example, a software system may memorize user navigation paths in the application user interface (UI). If several users follow the same navigation path, the application can discover and memorize a navigation pattern that describes the behavior of such users. Later, the application can use the discovered pattern to guide new users through the user interface and increase application usability. However, since different users expose various behaviors, discovering inter-relations between user actions is a non-trivial task.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with their advantages, may be best understood from the following detailed description taken in conjunction with the accompanying drawings.

FIG. 1 is a block diagram illustrating an exemplary system for predictive insight analysis over data logs, according to one embodiment.

FIG. 2 is a flow diagram illustrating a process for predictive insight analysis over data logs, according to one embodiment.

FIG. 3 is a block diagram illustrating an exemplary system for predictive object rating based on data analysis, according to one embodiment.

FIG. 4 is a flow diagram illustrating a process for predictive object rating based on data log analysis, according to one embodiment.

FIG. 5 is a block diagram illustrating an exemplary set of event data collection to be used for predictive insight analysis, according to one embodiment.

FIG. 6 is a block diagram illustrating an exemplary data analysis computation for determining causality measure, according to one embodiment.

FIG. 7 is a block diagram illustrating an exemplary causality table including causality rates associated with insight analysis over data logs, according to one embodiment.

FIG. 8 is a block diagram illustrating exemplary Wilson intervals determined during analysis of collected data logs, according to one embodiment.

FIG. 9 is a block diagram illustrating an embodiment of a computing environment in which the techniques described for predictive insight analysis over data logs can be implemented, according to one embodiment.

### DETAILED DESCRIPTION

Embodiments of techniques for predictive insight analysis over data logs are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Enterprise software applications leave massive footprints and may maintain extensive data logs. Traditional applications leverage these logs for routine tasks such as analysis and audit. It is possible to analyze such log to discover knowledge and predict pattern behavior. Discovering knowledge through log analysis may allow turning this information into added value for the customers and end-users of software applications. However, logs are typically ambiguous and inconsistent. This impedes the knowledge discovery process. In particular, it is a challenge to discover relations and causality between user actions, events, executed tasks, requests, etc.

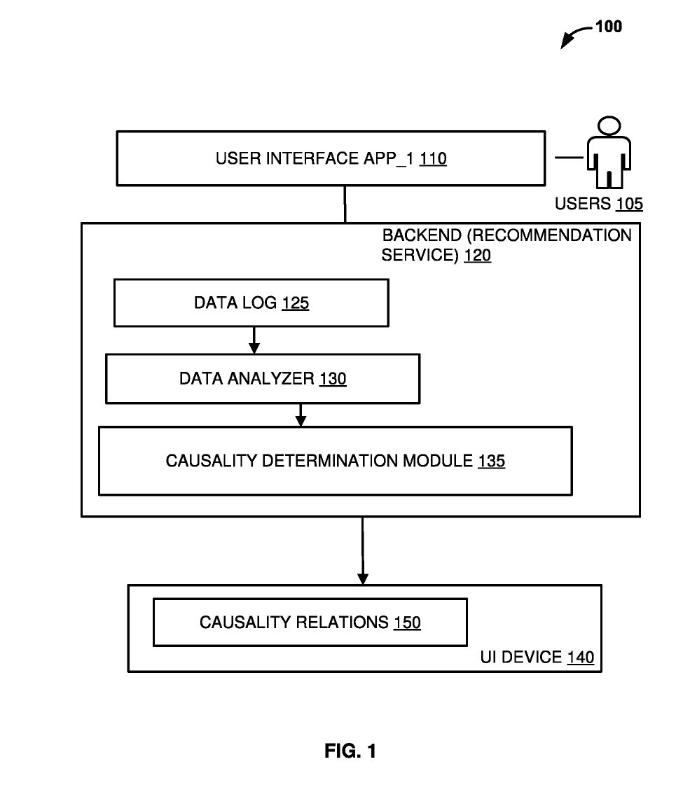

FIG. 1 is a block diagram illustrating an exemplary system 100 for predictive insight analysis over data logs, according to one embodiment.

The exemplary system 100 may be utilized to discover knowledge about causality between events from large data collections. For example, the exemplary system 100 may be used as part of a human capital management application to discover insight over collected data from employees regarding employees' satisfaction, employees' demands and actions. In order to increase people's satisfaction, feedback data may be collected and analyzed to provide recommendations based on an intelligent data analysis performed in the context of exemplary system 100.

In one embodiment, a UI application (UI APP_1) 110 may provide display screens to collect data in relation to providing ratings for available events. The UI APP_1 110 may be a cloud-based solution associated with backend 120. For example, if the UI APP_1 110 is a human capital application interface collecting feedback on employees' satisfaction, backend functionality 120 may include a recommendation service that provides implemented logic to identify relations between impacting events and impacted events.

Within the scenario of evaluation of employees' satisfaction, an employee may identify demands as related to their job and determine actions addressing their demands. In one embodiment, demands may be interpreted as impacted events, and actions may be impacting events.

Exemplary demands may be related to work life balance, team climate, direct manager leadership. Exemplary actions that may address such demands may be for example, home office availability, team events, trainings, etc.

The backend 120 includes a recommendation service that may determine actions having positive impact on demands, thus identify causality between events.

Users 105 may interact with UI APP_1 110 and provide feedback answers to imposed questions presented at user screens of the UI APP_1 110. The answers to the questions may be stored in data logs, such as data log 125. The data log 125 may include information for the users and their interactions with the UI APP_1 110. The interactions with the UI APP_1 110 may include information about answers to questions, which were answers by the users 105. The answers to the questions may be examples of feedback from users that is stored in the data log 125.

The recommendation service provided at the backend 120 may include implemented logic at data analyzer 130 to evaluate data within the data log 125. Based on implemented logic, it may be determined whether a given event has a positive or negative impact on a second given event. With regards to the example of a human capital scenario, it may be determined whether work life balance is affected by introduction of home office policy within a company, or whether team events are those that impact the work life balance.

Different exemplary scenarios outside the human resource field may be provided. The described embodiments herein are not limited to the particular area of employee satisfaction. The analysis of data logs to determine causality of events may be implemented in different working fields, such as studying techniques, service level satisfaction, evaluation analysis, product ratings, etc.

When it is determined whether a particular action has a positive impact one given demand, this insight may assist in planning activities. The determination of the causality of events is performed through specific analyzing and computational steps defined at the data analyzer 130 and causality determination module 135, where such analyzing and computation steps are to be performed over data from the data log 125.

With increasing popularity of cloud solutions, collecting and mining of big data are becoming core tasks for software system. However, the benefit of a vast amount of data depends primarily on its consistency, completeness, as well as reliability. Often, data is generated by humans, such as end users 105 of the UI App_1 110. Therefore, the generated data from interactions of the users 105 and stored at data log 125 may be subjective. A prerequisite for analyzing data sets is to extract objectiveness from the given subjective data. Therefore, before starting to seek insights from data, its quality should to be quantified.

Frequently, data quality metrics are defined for individual evaluations. An object with several evaluations may be provided from the UI APP_1 110 to be stored at data log 125. The object may be for example a question provided at the UI APP_1 110, seeking answers from the users 105 according to a defined rating criterion. The rating criterion may be as simple as good or bad, positive or negative. The data log 125 therefore includes data for that object from different people (users). Such data may be used to predict the object's overall evaluation. As a prerequisite it may be suggested that it is determined whether the ratings at hand are sufficient for learning the true object rating. In such manner, a recommendation service may determine helpful actions in response to determined demands to avoid destructive actions. However, the task to determine exact correlations between actions and demands, or impacting events and impacted events in a general context may be a difficult task. For example, it may be received as feedback that people who want to have a better work life balance, also want to have a better team climate, and such people may provide feedback which defined that for those two demands they highly value the home office availability option and trainings. As this is not a direct correlation between a demand and action, from collected feedback it may be interpreted what exactly has an impact on the work life balance, whether this is the home office or the trainings. Whereas general knowledge in the field may be used to interpret what such received data may mean, this does not necessary correspond to the answers provided by users. Therefore, a thorough analysis over a large number of collected data may be performed to interpret the data collected and not to apply other external theories to define causality relations between demands and actions.

In the context of the human capital application and employee satisfaction survey, the focus may be on employee behavior exposed when providing feedback about invoked actions. Different scenarios may be defined, however the inventive concept here is related to determining causality between impacting events and impacted events. Such impacting and impacted events may be interpreted as demands and actions, needs and requirements, which examples share the characteristic of providing impact of one event over another.

Through the UI APP_1 110, when the user reports a change of demand satisfaction, he can claim which action is responsible for this change. Such feedback may be directly stored at the data log 125. If the user satisfaction increases, we consider that the associated action positively influences the demand. When user satisfaction declines, we conclude that the associated action negatively affects the demand. We may assume that user behavior is described by a set of events, denoted by E. We model demands and actions of a user as types of such events.

The set of events E may be associated with a user behavior, and therefore the UI APP_1 may request feedback to be logged at data log 125 in relation to the set of events E. The set of events E may include events of different type, and an event from set E may be mapped to a type from a set of types denoted by T. The mapping of events E to type T may be denoted by function f1 as below in formula (1):

f₁:E→T (1)

For example, events that affect user behavior of user X may be of type: work life balance, team climate, direct manager leadership, home office, team event, and trainings. The user X may claim through the UI APP_1 110 that his current demands are work life balance and direct manager leadership, which corresponds to two individual events e₁ and e₂. Therefore, f₁(e₁)=work life balance and f₁(e₂)=direct manager leadership.

In one embodiment, an event type t from event types T may be categorized as either impacting, or impacted, i.e. there is a function f₂ defined as follows in formula:

f₂:T→I={impacting,impacted} (2)

User feedback, received through the UI APP_1 110 at the data log 125 may be defined as including claimed relations between events of one type to events of another type. A claim from the claimed relations is associated with a user, such as a user from users 105. A claim may state that a set of impacting events causes a set of impacted event. The claim has the form: L=>R,

where L={e∈E: f₂(f₁(e))=impacting}

and R={e∈E: f₂(f₁(e))=impacted}.

Such a generic form may enable users to provide feedback in a fast and flexible manner. At the same time, it is a challenge to understand from such a statement which impacting event causes which impacted event, as a one to one causality interpretation. The user specifies which set of actions impacts which set of demands.

For example, an employee provides feedback at the UI APP_1 110 stating that her demand work life balance has improved, the direct manager leadership has worsened, both due to actions home office and training: {home office, training}=>{work life balance, direct manager leadership}. However, it is not clear which action has an impact on which demand. Furthermore, it is unclear which action had a positive effect and which had a negative effect. Therefore, it is essential to reveal causality between the observed events.

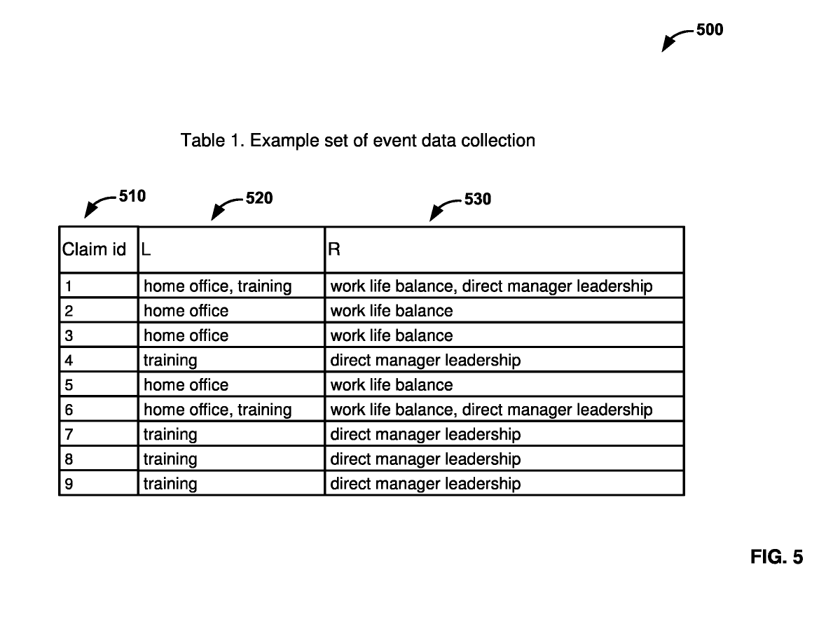

In such manner, data analyzer 130 receives the data stored at data log 125. The data log 125 includes stated relationships between events. For example, data stored at data log 125 that may be analyzed may be such as exemplary data described at FIG. 5 below. The received data is to evaluated to determine causality measures for pair of events within a given relationship statement. A pair of events within a statement maps one impacting event with one impacted event. Therefore, for a given relationship statement, where there are 2 impacting event and 2 impacted events, 4 pairs of events of different type may be defined.

To discover causality in a more precise manner, claimed statements, as feedback of multiple users, are to be evaluated at the data analyzer 130. The key assumption is that the more users claim an impact of one event type on another event type, the stronger is the causality between the two event types. If a small number of users claim that one event type impacts another event type, these claims are too sporadic to infer causality between the two event types. However, if many users claim that one event type impacts another event type, the causality between them is strong.

It may be assumed that the more data is observed at the data analyzer 130 received from the data log 125, the more reliable prediction can be provided. For instance, if two people positively evaluate an object, we may conclude that this object has a positive rating. If there are one thousand of positive opinions about an object, we may also deduce that its true rating is positive. However, in the second case, when observing a larger amount of opinions, we are more confident that our conclusion is correct. Second, the more homogeneous data is observed, the more reliable predictions can be provided. However, if half of one thousand opinions are positive, while the other half is negative, it is hard to decide if the true rating is positive or negative.

Data quantity for the analyzed data is desirable because more available ratings for a statement or object may increase the accuracy of predicting the share of positive ratings. Data consistency for the analyzed data is also described because of the variation of individual ratings. For example, a statement or object with either only negative or only positive ratings is an example of consistent data. Overall, a large amount of homogenous data allows for being confident that we can truly learn from it.

Given the statement L=>R, a trivial solution is to conclude that every event in L influences every event in R. In practice, however, such a solution may be ambiguous and imprecise. Consider the example with the employee needs and demands: {home office, training}=>{work life balance, direct manager leadership}. For this example, it may be concluded that home office impacts both employee demands work life balance and direct manager leadership. While an impact of home office action on work life balance demand seems to makes sense, it is questionable if home office causes changes in the satisfaction with direct manager leadership. Similar, training for a manager may impact the direct manager leadership, but is unlikely to be relevant for changes in work life balance. Therefore, precise analysis over stored data is required. A method that may determine causality between the events more precisely may be utilized.

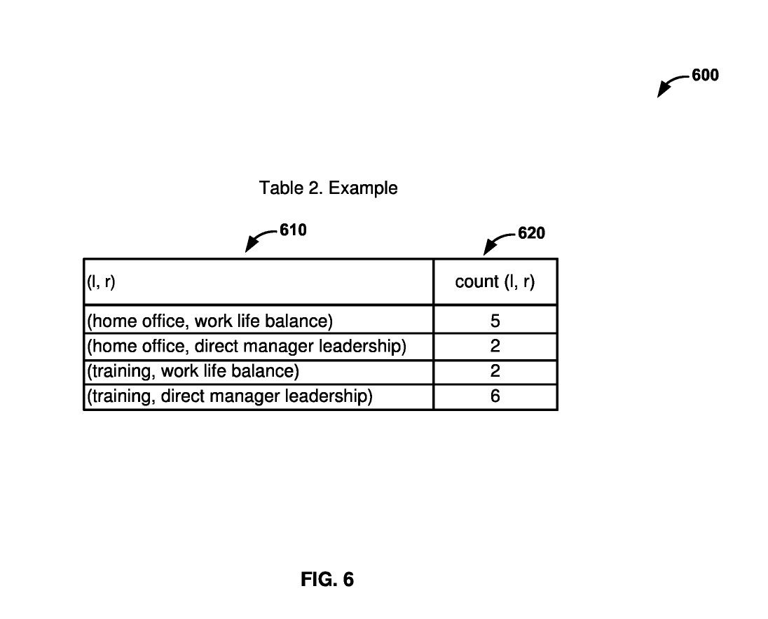

In one embodiment, a causality determination module 135 may communicate with data analyzer 130 and may determine event causality measure. The data analyzer 130 may analyze statements received from collected data at the data log 125. The analyzed statements are in the form of L=>R, where the UI APP_1 110 understand the definition of statements in such a form and provides collected data from users 105 in such form to the data log 125. Within the analysis of statements at the data analyzer 130, total number of occurrences of possible pairs of impacting and impacted event types is computed. Let us denote the number of occurrences of events eᵢ and eⱼ as: count (eᵢ, eⱼ), where eᵢ∈L, eⱼ∈R. Exemplary analysis over statements may be performed as described below in relation to FIG. 6, over data as presented in FIG. 5.

The causality may be calculated at the causality determination module 135 as follows. Having the count information received from the data analyzer 130, the causality measure between pair of events within in a statement L=>R may be computed as follows. The data analyzer 130 provides calculated counted occurrences of possible combination of an event of type R with an event of type L as defined in a given claimed statement. The causality measure for pairs (l, r) of events, where l is selected from L and r is selected from R, may be computed according to formula (3) below:

$$casuality ( l , r ) = \frac{count ( l , r )}{{Σ}_{e ∈ R} count ( l , e )} \qquad ( 3 )$$

When formula (3) is used for computing causality measure for a pair of events of different type, for a given statement as claimed in the data log 125, a set of causality measures is determined. The number of measures in the set corresponds to the possible combinations of an event selected from L with an event selected from R. The possible combinations may be defined as an exhaustive set of combinations of events within a pair of events.

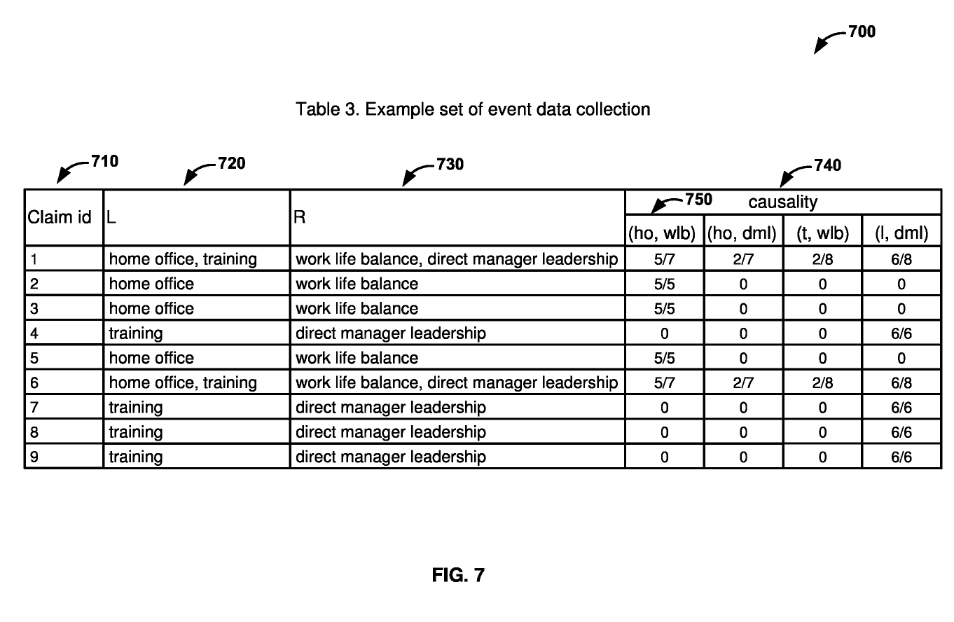

In one embodiment, causality measures may be determined for the statements from the data log 125 that are analyzed. Exemplary computed causality measures for analyzed data log is presented below in relation to FIG. 7.

Further, a set of measures determined per statement is computed to be with a comparable value. Based on comparing the computed causality measure values, it may be determined which is the relationship between an event from L and an event from R, which is with a strongest causality effect.

In one embodiment, the backend 120 may communicate with a UI device 140 to provide causality relations 150 that are determined by the causality determination module 135 according to analysis performed based on data included in the data log 125.

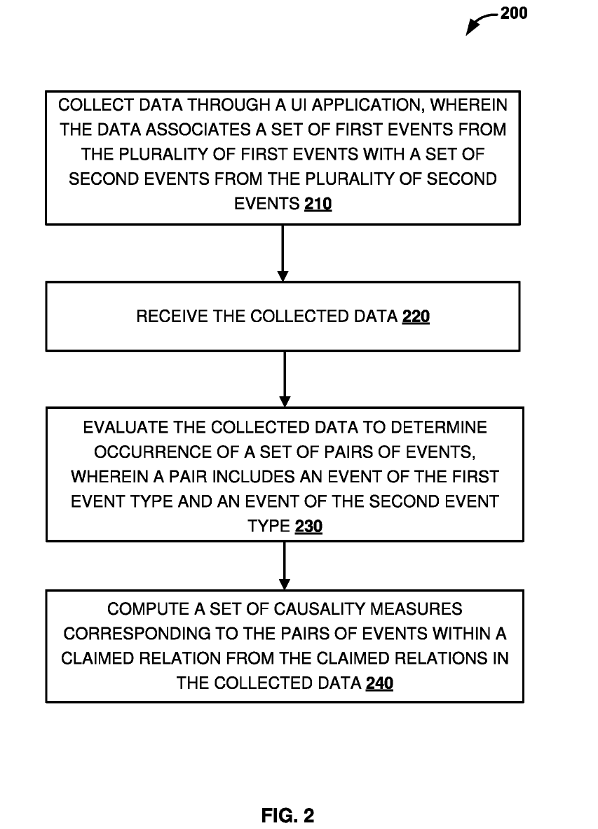

FIG. 2 is a flow diagram illustrating a process 200 for predictive insight analysis over data logs, according to one embodiment. In one embodiment, at 210, data is collected through a UI application. The data may be collected at a data log, such as data log 125. The data log may be a database part of a back-end application. The collected data associates a set of first events with a set of second events. The first events are selected from a plurality of first events, which may be defined as impacting events. The second events are selected from a plurality of second events, which may be defined as impacted events.

An association of a number of first events with a number of second events may be performed through selections performed at a UI screen of an application. The association may be defined between sets of events of different cardinality. The associations may be defined through an UI application, such as the UI APP_1 110, FIG. 1, based on interaction with users 105, FIG. 1.

An association defines a claimed relation for an object from a set of objects. The set of first events are of a first event type, and the set of second events are of a second event type. A number of associations may be collected within the data log to represent a number the set of objects being associated with the plurality of first events and the plurality of second events. The collected data at 210 may be included inconsistent information about events and direct relations between two events of different type.

The collected data at 210 is received at 220.

At 230, the collected data is evaluated to determine occurrence of a set of pairs of events, wherein a pair includes an event of the first event type and an event of the second event type. The evaluation as defined at 230 may correspond to analysis performed by the data analyzer 130 as described in relation to FIG. 1.

At 240, a set of causality measures corresponding to the pairs of events are computed. The set of causality measures are determined per a claimed relation/association from the claimed relations in the collected data. Exemplary table of computed plurality of sets of causality measures per defined association is provided at FIG. 7.

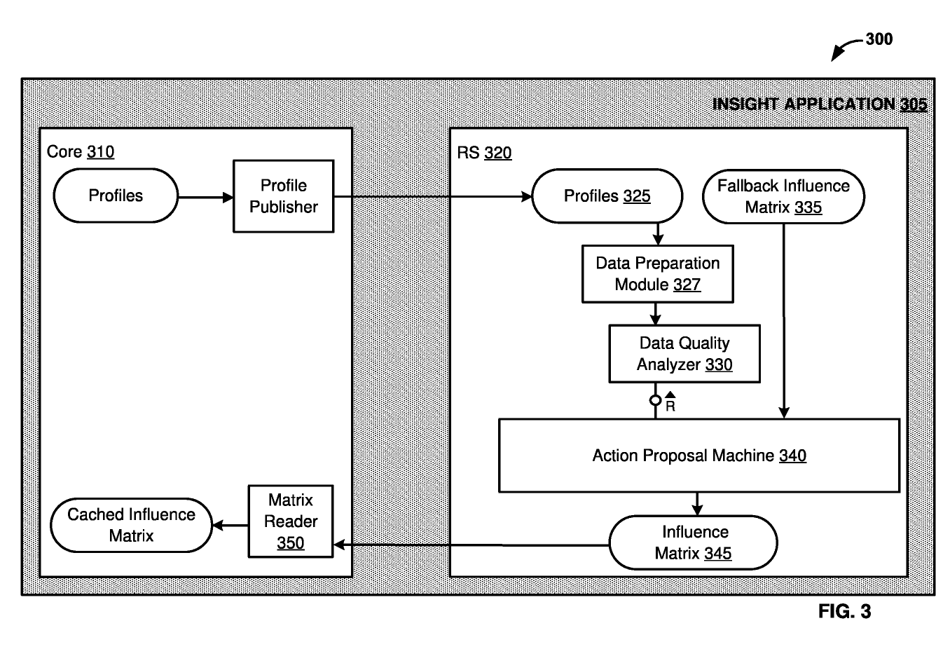

FIG. 3 is a block diagram illustrating an exemplary system 300 for predictive object rating based on data analysis, according to one embodiment.

In one embodiment, an insight application 305 is provided to generate personalized action recommendations for people profiles based on provided data input. For example, the people profiles may be employees, and provided input may be employees' feedback collected through people surveys conducted through software systems. A data collection application may be suggested such as a UI Application for collection of user input to allow for receiving feedback about impact of a suggested set of actions on an identified need or demand. Such feedback may be collected in form of a data log and used to generate and refine recommendations for future actions corresponding to the feedback.

For example, within the previously discussed scenario of employee satisfaction surveying, an employee may define what he demands in his current situation at work, i.e. work life balance, and how satisfied he is with this concern currently. Such employee demands may be collected through the UI application. Different events may be suggested to address employee's demands. In this scenario, the demands may be treated as impacted events and the taken actions for satisfying demands may be appreciated as impacting events. It may be suggested that an event of home office is provided to the employee. Once the employee had the possibility to experience the impact of this action, he may provide feedback through the UI application for a change in satisfaction. Therefore, his feedback may be stored in form of a relation L=>R, as discussed above in relation to FIG. 1. The claimed relation between work life balance and home office may be defined according to a rating scale. The scale may be binominal or it may be a scale of 10, or of other granularity or quality identification. The claimed relation may be saved and provide to the system 300 to be used to determine the influence of home office.

In one embodiment, the insight application 305 includes a core 310 module and a recommendation service (RS) 320 part. The core 310 includes data for profiles, such as employee's profiles. The profiles may be data associated with impacted events, for example claimed demands from employees. An object stored in the profiles may be a pair {Work Life Balance, Home Office}, and a rating for the object may be stored. The rating is the impact, or change in satisfaction in response to applying the action for the need. The rating may be collected and stored as part of the profiles. Once such data is collected, an aim to predict which action has a positive impact on which need may be defined.

To be able to define a predicted impact of an action on a demand, data analysis over data logs including such claims and ratings may be evaluated. The quality of the available ratings may be evaluated.

At RS 320, profiles stored at 325 may be received through the profile publisher provided by the core 310. The RS 320 stores profiles 325 including claimed rating of association of impacting events and impacted events, e.g. actions and demands.

Data quantity and data consistency is required for the data in profiles 325, in order to be evaluated and to determine effect between events. A large amount of homogenous data allows for being confident that the determined result can truly be interpreted to extract knowledge for the objects associated with the data logs, for example, employees.

The data stored at profiles 325 is to be analyzed and evaluated through a data preparation module 327.

It may be assumed that the more data is observed at the profiles 325, the more reliable prediction can be provided. For instance, if two people positively evaluate an object, we may conclude that this object has a positive rating. If there are one thousand of positive opinions about an object, we may also deduce that its true rating is positive. However, in the second case, when observing a larger amount of opinions, we are more confident that our conclusion is correct. Second, the more homogeneous data is observed, the more reliable predictions can be provided. However, if half of one thousand opinions are positive, while the other half is negative, it is hard to decide if the true rating is positive or negative.

Higher data quantity of analyzed data is desirable because more available ratings for a statement or object may increase the accuracy of predicting the share of positive ratings. Data consistency for the analyzed data is also described because of the variation of individual ratings. For example, a statement or object with either only negative or only positive ratings is an example of consistent data. Overall, a large amount of homogenous data may confirm whether the analyzed data is to be used for insight analysis learn and providing recommendations.

In one embodiment, the data stored at profiles 325 includes data such as the data in data log 125, FIG. 1. The data at the profiles 325 is analyzed based on implemented logic at a data preparation module 327. The data in the profiles 325 includes relations between impacting events and impacted events, where such relation may be defined in form of many to many relations. For example, two impacting events may be associated with two impacted events. Examples of such relations of events are provided for example in relations discussed in association with FIG. 1, FIG. 5, other. The implemented logic in the data preparation module 327 includes evaluation of the collection of data events with defined relations and performing a predictive insight analysis over data profiles. The performed insight analysis may be such as the disclosed analysis in relation to FIG. 2.

Based on the analysis performed at the data preparation module 327, relations in the form of one to one may be defined, where for example one impacted event is associated with one impacting event. Such relations of events, in form of binary statements, may then be evaluated based on the logic implemented in the data quality analyzer 330.

In one embodiment, ratings stored for relations of impacting and impacted events in binary form may be interpreted on a binary scale, e.g. positive and negative, which may be interpreted as 0 and 1. Such logic for evaluating statements relating two events (e.g. one impacting and one impacted event) is implemented in the data quality analyzer 330. When we deal with binary ratings, the problem of rating prediction may be transformed as described. If positive ratings significantly dominate, it may be concluded that the object has a positive evaluation. If the share of positive ratings is significantly less than the share of negative ratings, the object is negatively evaluated.

In one embodiment, a Wilson interval may be defined, which is a subinterval of the unit interval [0, 1], to predict the share of positive ratings. A confidence level for computing the Wilson interval may be defined. The confidence interval represents the tendency of the expected outcome in repeated experiments, namely receiving future rating.

The data quality analyzer 330 may calculate the Wilson interval as follows. Let p denotes the observed fraction of positive ratings among a total of n ratings as stored in profiles 325, and denote z_{α/2} to be the α/2-quantile of the standard normal distribution. The formula for the lower and upper bounds of the Wilson interval is:

$$\frac{p + \frac{{z}_{α \text{/} 2}^{2}}{2 n} \pm {z}_{α \text{/} 2} \sqrt{\frac{p ( 1 - p ) + \frac{{z}_{α \text{/} 2}^{2}}{4 n}}{n}}}{1 + \frac{{z}_{α \text{/} 2}^{2}}{n}} \qquad ( 4 )$$

For a confidence level of 0.95, set z=1.96 in Formula (4). This level can be adjusted at the data quality analyzer 330 to fit the requirements of a given task. [symbol] In one embodiment, the position of the Wilson interval within [0, 1] may be evaluated against a threshold value, such as the midpoint 0.5 of the interval, as the rating is binary. If the interval lies completely on one side from 0.5, it may be determined that the data has enough quality for being used for machine learning and extracting causality relations based on evaluations of log data.

The Wilson interval addresses the data quantity and data consistency properties identified. The position of the Wilson interval corresponds to the data consistency property. Data of high quality results in a short Wilson interval that lies close to one end of the [0, 1].

If none of the Wilson intervals constructed from the ratings of claimed relations, involving, for example, the need “Childcare” to meet the requirements, for example employee's demands for work life balance, a fallback solution may be triggered to be determined at fallback influence matrix 335, in order to determine actions, associated with employees with the need “Childcare”. The Wilson interval may be a useful indicator to determine when the existing need profiles, as stored in the profiles 325, contain sufficient data for machine learning step to be performed, or whether the fallback solution may be utilized.

The determination of causality between events based on data analysis performed at the data quality analyzer 330 may be performed at the action proposal machine 340. The action proposal machine 340 may evaluate computed Wilson intervals for claimed relations between events and thus define whether an influence matrix 345 may be determined based on the analyzed data, or whether a request for a fallback solution may be send to the fallback influence matrix 335.

### EXAMPLES

Example 1 defines an exemplary scenario of calculating and interpreting a Wilson interval within an exemplary claimed relation of the action Home Office, which has a positive impact on the need Work Life Balance. The collected data includes 16 positive ratings between the two events of different type—action and need; and only one negative rating for this pair. When the Wilson interval is calculated for the data set, the interval (0.73, 0.99) is computed at a confidence level of 0.95. Decreasing the confidence level to 0.8, the interval becomes (0.82, 0.98). In both cases, the interval lies to the right of 0.5 within the unit interval, which allows defining that there is a positive correlation between Home Office and Work Life Balance.

Example 2 defines an exemplary scenario of calculating and interpreting a Wilson interval having 6 positive ratings among 7 ratings overall for a particular pair of action and need. At a confidence level of 0.95, the interval is computed to (0.49, 0.97). Only at a confidence level of 0.8, the pair would be considered of good enough quality based on its Wilson interval (0.62, 0.96). This example demonstrates yet again the flexibility of the Wilson interval, which can be adjusted to fit numerous problems.

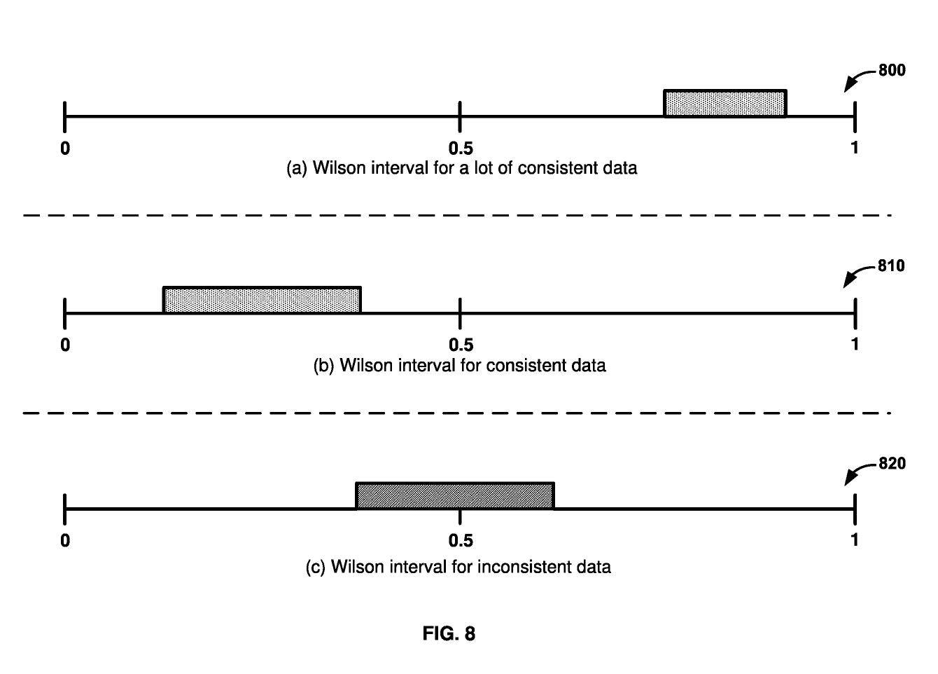

Exemplary positioning of computed Wilson intervals within the range of 0 to 1 are presented in FIG. 8.

Based on evaluation of computed Wilson intervals according to the data being evaluated, which is the data in profiles 325, it may be determined that the data is of sufficient data quality and consistency in order to determine unanimous causality conclusion and provide an influence matrix 345 including relations between events that have a determined causality effect.

The influence matrix 345 may be provided from the RS 320 to the core 310 through the matrix reader 350. The matrix reader 350 may store provided influence matrices, such as influence matrix 345, in a cache storage at the core 310.

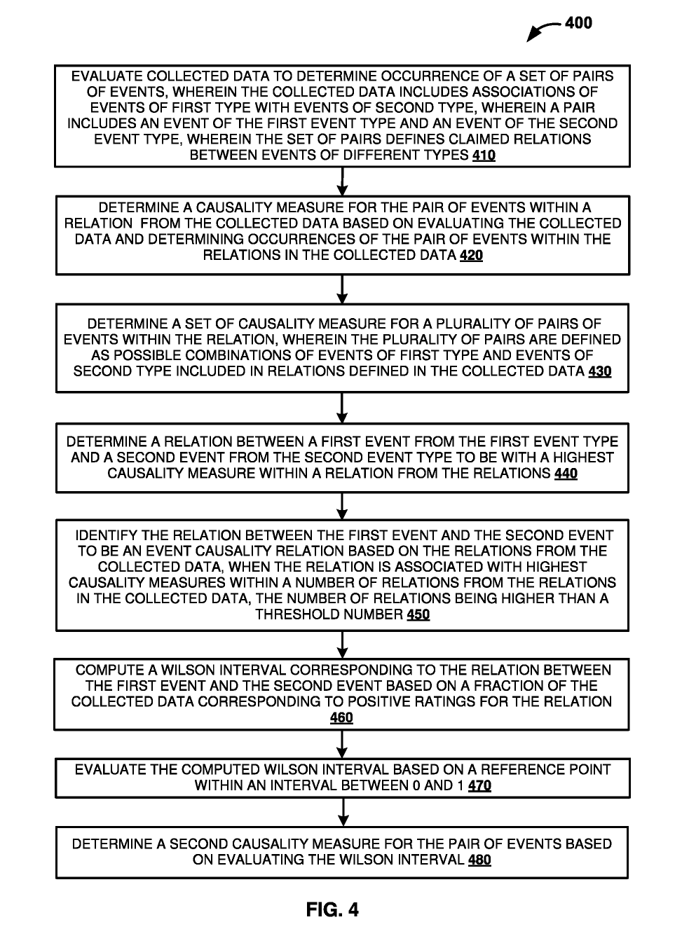

FIG. 4 is a flow diagram illustrating a process 400 for predictive object rating based on data log analysis, according to one embodiment.

At 410, collected data is evaluated to determine occurrence of a set of pairs of events. The collected data includes associations of events of first type with events of second type. A pair includes an event of the first event type and an event of the second event type. The set of pairs defines claimed relations between events of different types. The collected data may be such as the discussed collected data in relation to FIGS. 1, 2, and 3, and also as presented in Table 500 on FIG. 5.

At 420, causality measure for the pair of events is determined within a relation from the collected data. The causality measure is determined based on evaluating the collected data and determining occurrences of the pair of events within the relations in the collected data. The determination of occurrences of the pair of events may be such as the described determinations in relation to FIG. 1 and FIG. 2.

At 430, a set of causality measure for a plurality of pairs of events within the relation is determined. The plurality of pairs is defined as all possible combinations (also referred as exhaustive set of combinations) of events of first type and events of second type included in relations defined in the collected data that is evaluated at 410.

At 440, a relation between a first event from the first event type and a second event from the second event type is determined to be with a highest causality measure within a relation from the relations.

At 450, the relation between the first event and the second event is determined to be an event causality relation based on the relations from the collected data, when the relation is associated with highest causality measures within a number of relations from the relations in the collected data, the number of relations being higher than a threshold number.

At 460, a Wilson interval is computed corresponding to the relation between the first event and the second event, based on a fraction of the collected data corresponding to positive ratings for the relation. The computation of the Wilson interval may be formed as described above in relation to FIG. 3 and formula (4). An evaluated relation with the Wilson interval may be a relation of events having highest causality measures as determined at 450, may be a relations of event with lower causality measures compared to the highest causality measure determined. In some embodiments, the lower causality measures are determined based on a number of relations higher than the defined threshold value.

At 470, the computed Wilson interval is evaluated based on a reference point within an interval between 0 and 1.

At 480, a second causality measure for the pair of events is determined based on evaluating the Wilson interval. The evaluation of the Wilson interval may be as discussed above in relation to FIG. 3. Different positioning of Wilson interval in relation to the reference point are described in the examples provided below in relation to FIG. 8.

FIG. 5 is a block diagram illustrating an exemplary set 500 of event data collection to be used for predictive insight analysis, according to one embodiment. The event data presented at exemplary set 500 may be data collected through the UI APP_1 110 as described in FIG. 1, which is analyzed and causality measures between impacting event and impacted event are determined.

The exemplary set 500 is presented in form of a table, where a claimed association between impacting events and impacted events is stored as a separate row. Column 510 defined the identification “Claim Id” of the associations. A row from the table may correspond to one object, for example, one user of a system, one employee of a company, one respondent of a survey, etc.

Column 520 includes records with set of events of a first type, and column 530 includes sets of events of a second type. A given association is depicted as a selection of events from first type, and events from the second type. A set of events of the first type and a set of events of the second type, as defined within a row of the table at FIG. 5 represent a statement defined in form of L=>R, where a plurality of first type events are denoted as L, and a plurality of second type events are denoted as R. The plurality of events L and R may be defined for a given data analysis scenario, for example within a survey to be executed through a software system. Analysis over collected data including claimed relations between one or more events from set L and one or more events of set R may be performed as described in relation to FIGS. 1, 2, 3, and 4 above.

The exemplary set 500 may define claimed associations of employee actions and demands, as collected as employee's feedback through a computer executed survey or other form of collection of data. Table 1 shows the available event collection that is presented just for purposes of the example. The data in Table 1 may be analyzed as discussed above, for example, as in relation to FIGS. 1 and 2.

FIG. 6 is a block diagram illustrating an exemplary data analysis computation for determining causality measure, according to one embodiment. “Table 2” 600 is an example of a computation of possible event pairs corresponding to pair defined based on the data presented in FIG. 5. Table 2 600 defines the occurrences of event pairs for the example in Table 1. Table 1 in FIG. 5 includes four events in total, where 2 event are of type action, and 2 events are of type demand. The events of type action are home office and training, the events of type demand are work life balance and direct manager leadership. As there are 2 events of type L and 2 events of type R, the number of pairs that may be determined is 4, and the pairs are defined within column 610 (l, r). In the second column 620 of Table 2 600, for a pair of an impacting event and impacted event, a count of occurrences within the data in Table 5 is determined.

For example, for the first record {home office, work life balance}, the count of occurrences is determined to be 5, because home office and work life balance are present in claims with ids 1, 2, 3, 5 and 6, corresponding to rows from Table 1 presented on FIG. 5.

Now it is possible to calculate causality measures for the illustrated claims in FIG. 5 based on counts computed at FIG. 6.

FIG. 7 is a block diagram illustrating an exemplary causality table 700 including causality rates associated with insight analysis over data logs, according to one embodiment. Table 3 presents the causality measure values. The matrix 700 includes several columns.

Column “Claim id” 710 refers to the association defined at the table including the data log from FIG. 5.

Column “L” 720 refers to the sets of events of first type defined in the data log from FIG. 5.

Column “R” 730 refers to the sets of events of second type defined in the data log from FIG. 5.

Columns 740 present computed causality measures for the pairs of an event of first type and an event of second type. The event of first type is selected from the events defined at different rows of column L 720. The event of second type is selected from the events defined at different rows of column L 720. The pair defined based on data in column L 720 and R 730 are 4, as there are 2 events of first type—home office and training, and there are 2 events of second type—work life balance and direct manager leadership. Possible combinations to define pairs of two, where one of the elements of the pair is selected from a group of two, and the other is also selected from another group of two, is determined to 4.

In table 3 700, the causality rates are computed at section 740, where for every claim id corresponding to a defined association with a data log, a set of causality rates are computed corresponding to the set of pairs determined. Within the current example, for every claim a set of 4 measures is determined.

For example, for claim id 1, a causality rate corresponding to pair (home office, work life balance) 750 is computed to 5/7. The causality rate is computed based on formula (3) above. Once causality rates are computed within the causality column section 740, it may be determined that there is a higher causality between home office and work life balance, then between training and work life balance, as 5/7 is greater than 2/7.

FIG. 8 is a block diagram illustrating exemplary Wilson intervals determined during analysis of collected data logs, according to one embodiment. For example, the Wilson intervals may be determined in the context of embodiments described in relation to FIG. 3 and FIG. 4.

The three intervals in FIG. 8 depict different levels of data quality. For diagram 800 and 810, it may be determined that the collected data to be evaluated comprise consistent enough data to predict future ratings of the object in question. The upper bound of the interval in diagram 810 is less than 0.5, while the lower bound of the interval in diagram 810 is greater than 0.5. In particular, the interval in diagram 800 is shorter, possibly because there was more data available than in the second situation of diagram 810. The interval in diagram 820 is not only relatively long, but contains the midpoint 0.5 of the interval, which is used as a reference point. Therefore, the data used for computing the Wilson interval presented on diagram 820 is ambiguous and is not sufficient to learn from it.

The suggested method allows quantifying the data quality of binary ratings via a simple formula. Thus, the computation of the Wilson interval bounds is very efficient, with a computational complexity of O (1). The embodied technique for computation is very flexible and allows for adjusting the confidence level to the individual task and data set provided, which may be defined through configurations and interaction with the data quality analyzer, such as the data quality analyzer 330, FIG. 3.

A maximum length for the interval length can be set in order to establish a desired accuracy of the final rating. It may be configured that ratings of objects are to be defined as acceptable are associated with some threshold values. For example, when distance d_{0.5} to 0.5 of the corresponding Wilson interval (a, b)⊂[0, 0.5) or (a, b)⊂(0.5, 1] encompasses some threshold, such a rating would be acceptable. In the given example d_{0.5} is defined as follows: d_{0.5}=0.5−b, if b<0.5, and d_{0.5}=a−0.5, if a>0.5

In such manner, data quality for a complete life cycle of a data collection experiment may be evaluated.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

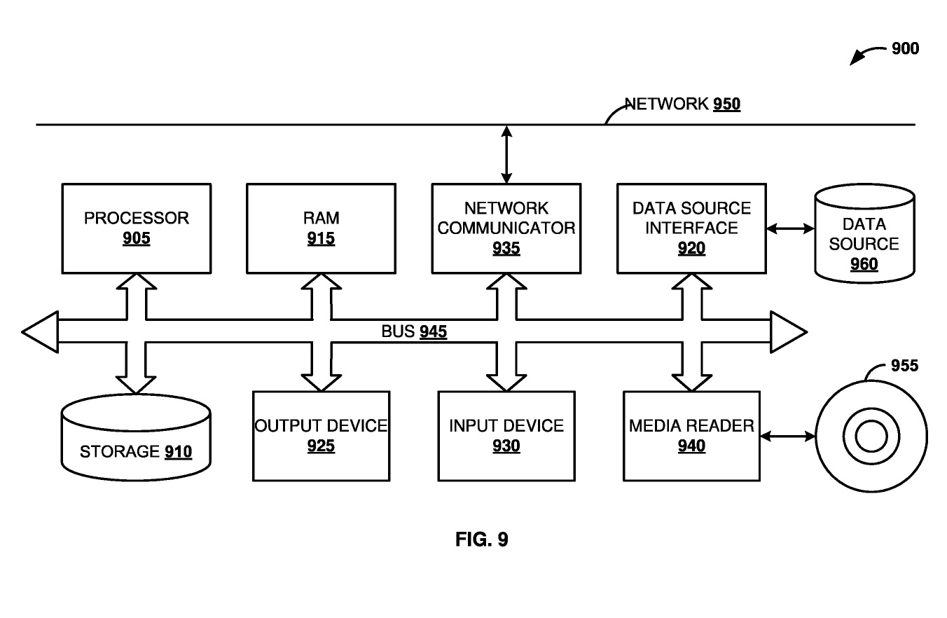

FIG. 9 is a block diagram of an exemplary computer system 900. The computer system 900 includes a processor 905 that executes software instructions or code stored on a computer readable storage medium 955 to perform the above-illustrated methods. The processor 905 can include a plurality of cores. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. According to some embodiments, such as some in-memory computing system embodiments, the RAM 915 can have sufficient storage capacity to store much of the data required for processing in the RAM 915 instead of in the storage 910. In some embodiments, all of the data required for processing may be stored in the RAM 915. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments, the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope of the one or more embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to perform predictive data analysis over data logs, the method comprising:
receiving collected data for relations between sets of first events and corresponding sets of second events, wherein the first events are of first event type, and the second events are of second event type;
evaluating the collected data to determine an occurrence of a set of pairs of events, wherein a pair of events includes a first event and a second event; and
computing a set of causality measures corresponding to the pairs of events within a relation from the relations in the collected data.

2. The method of claim 1, wherein the first events are impacting events, and wherein the second events are impacted events.

3. The method of claim 2, further comprising:
defining, at a user interface (UI) application, a plurality of first events and a plurality of second events, wherein the plurality of first events and plurality of second events are associated with a set of objects; and
wherein the set of first events are selected from the plurality of first events, and the set of second events are selected from the plurality of second events.

4. The method of claim 3, wherein the set of pairs of events are defined as an exhaustive set of combinations of an event selected from the plurality of first events and an event selected from the plurality of second events.

5. The method of claim 3, further comprising:
collecting the data through a UI application for associating the set of first events from the plurality of first events with the set of second events from the plurality of second events, wherein the association defines a relation from the relations.

6. The method of claim 4, wherein the association is related to an object from the set of objects defined for collecting the data, and wherein the set of objects are associated with the plurality of first events and the plurality of second events.

7. The method of claim 5, wherein the set of objects are associated with a set of users of the UI application, and wherein the UI application includes implemented logic for collecting feedback through survey functionality associated with the plurality of first events and the plurality of second events.

8. The method of claim 7, further comprising:
providing the computed set of causality measures for the relation at the UI application.

9. The method of claim 3, further comprising:
determining a pair relation between a first event from the first event type and a second event from the second event type to be with a highest causality measure within a relation of a set of first events and a set of second events, wherein the relation is from the relations; and
identifying the pair relation between the first event and the second event to be an event causality relation based on the relations from the collected data, when the relation is associated with highest causality measures within a number of relations from the relations in the collected data, the number of relations being higher than a threshold number.

10. A computer system to perform predictive data analysis over data logs, comprising:
a processor;
a memory in association with the processor storing instructions related to:
receiving collected data for relations between sets of first events and corresponding sets of second events, wherein the first events are of first event type, and the second events are of second event type, and wherein the first events are impacting events, and wherein the second events are impacted events;
evaluating the collected data to determine an occurrence of a set of pairs of events, wherein a pair of events includes a first event and a second event; and
computing a set of causality measures corresponding to the pairs of events within a relation from the relations in the collected data.

11. The system of claim 10, wherein the data is associated with a plurality of first events and a plurality of second events, wherein the plurality of first events and plurality of second events are associated with a set of objects; and
wherein the system further comprises instructions related to:
collecting the data from a user interface (UI) application for associating a set of first events from the plurality of first events with a set of second events from the plurality of second events, wherein the association defines a relation from the relations.

12. The system of claim 11, wherein the set of pairs of events are defined as an exhaustive set of combinations of an event selected from the plurality of first events and an event selected from the plurality of second events.

13. The system of claim 11, wherein the association being related to an object from the set of objects defined for collecting the data, and wherein the set of objects being associated with the plurality of first events and the plurality of second events.

14. The system of claim 11, wherein the set of objects are associated with a set of users of the UI application, and wherein the UI application includes implemented logic for collecting feedback through survey functionality associated with the plurality of first events and the plurality of second events.

15. The system of claim 14, further comprising instructions related to:
providing the computed set of causality measures for the relation at the UI application;
determining a pair relation between a first event from the first event type and a second event from the second event type to be with a highest causality measure within a relation from the relations associated with the collected data; and
identifying the pair relation between the first event and the second event to be an event causality relation based on the relations from the collected data, when the relation is associated with highest causality measures within a number of relations from the relations in the collected data, the number of relations being higher than a threshold number.

16. A non-transitory computer-readable medium storing instructions, which when executed cause a computer system to:
receive collected data for relations between sets of first events and corresponding sets of second events, wherein the first events are of first event type, and the second events are of second event type, and wherein the first events are impacting events, and wherein the second events are impacted events;
evaluate the collected data to determine an occurrence of a set of pairs of events, wherein a pair of events includes a first event and a second event; and
compute a set of causality measures corresponding to the pairs of events within a relation from the relations in the collected data.

17. The computer-readable medium of claim 16, further storing instructions to:
define, at a user interface (UI) application, a plurality of first events and a plurality of second events, wherein the plurality of first events and plurality of second events are associated with a set of objects;
collect the data through the UI application for associating a set of first events from the plurality of first events with a set of second events from the plurality of second events, wherein the association defines a relation from the relations; and
wherein the set of objects are associated with a set of users of the UI application, and wherein the UI application includes implemented logic for collecting feedback through survey functionality associated with the plurality of first events and the plurality of second events.

18. The computer-readable medium of claim 17, wherein an association being related to an object from the set of objects defined for collecting the data, and wherein the set of objects being associated with the plurality of first events and the plurality of second events.

19. The computer-readable medium of claim 17, wherein the set of pairs of events are defined as an exhaustive set of combinations of an event selected from the plurality of first events and an event selected from the plurality of second events.

20. The computer-readable medium of claim 19, further storing instructions to:
provide the computed set of causality measures for the relation at the UI application;
determine a pair relation between a first event from the first event type and a second event from the second event type to be with a highest causality measure within a relation from the relations; and
identify the relation between the first event and the second event to be an event causality relation based on the relations from the collected data, when the relation is associated with highest causality measures within a number of relations from the relations in the collected data, the number of relations being higher than a threshold number.
